(19) United States
(12) Patent Application Publication
(10) Pub. No.: US 2020/0034551 A1
(43) Pub. Date: Jan. 30, 2020

(54) SYSTEMS AND METHODS FOR PROVIDING INTERACTIONS BASED ON A DISTRIBUTED CONVERSATION DATABASE

(71) Applicant: Walmart Apollo, LLC, Bentonville, AR (US)

(72) Inventors: Robert L. Cantrell, Herndon, VA (US); Donald R. High, Noel, MO (US); Bruce W. Wilkinson, Rogers, AR (US); Todd D. Mattingly, Bentonville, AR (US); John J. O'Brien, Bella Vista, AR (US)

(21) Appl. No.: 16/523,978

(22) Filed: Jul. 26, 2019

Related U.S. Application Data
(60) Provisional application No. 62/711,434, filed on Jul. 27, 2018.

(51) Int. Cl. G06F 21/60; G06F 9/451; H04L 9/14; H04L 9/30; G06F 16/27; G10L 25/90; G10L 15/22; G10L 15/30; G10L 15/26

(52) U.S. Cl. CPC G06F 21/602; G06F 9/451; H04L 9/14; H04L 9/30; G10L 2015/223; G10L 25/90; G10L 15/22; G10L 15/30; G10L 15/265; G06F 16/27

(57) ABSTRACT

Systems, apparatuses, and methods are provided herein for providing voice-initiated conversation interface on multiple devices. Some such systems provide a voice-initiated conversation interface on multiple devices and comprise a network connector configured to communicate with one or more other user devices over a network, a user interface device configured to communicate with a user, a memory device storing at least a portion of a distributed conversation database, wherein the distributed conversation database comprises a plurality of conversation records encrypted with public keys associated with each conversation and conversation database is updated based on communications with the one or more other user devices via the network connector, and a control circuit.

### CROSS-REFERENCE TO RELATED APPLICATION

This application claims the benefit of U.S. Provisional Application No. 62/711,434, filed Jul. 27, 2018, which is incorporated herein by reference in its entirety.

### TECHNICAL FIELD

This invention relates generally to networked user devices.

### Background

Smart speakers have been developed to provide voice information to customers. For example, a user may ask a smart speaker to play music or answer a simple question. Similar voice assistance functionalities are also provided on some smartphones.

### BRIEF DESCRIPTION OF THE DRAWINGS

Disclosed herein are embodiments of apparatuses and methods for providing voice-initiated conversation interface on multiple devices. This description includes drawings, wherein:

FIG. 1 is a system diagram of a system in accordance with several embodiments;

FIG. 2 is a flow diagram of a method in accordance with several embodiments;

FIG. 3 is a flow diagram of a method in accordance with several embodiments;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings; and

FIG. 9 comprises a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing voice-initiated conversation interface on multiple devices. In some embodiments, a system for providing a voice-initiated conversation interface on multiple devices comprises a network connector configured to communicate with one or more other user devices over a network, a user interface device configured to communicate with a user, a memory device storing at least a portion of a distributed conversation database, wherein the distributed conversation database comprises a plurality of conversation records encrypted with public keys associated with each conversation and conversation database is updated based on communications with the one or more other user devices via the network connector, and a control circuit coupled to the network connector, the user interface device, and the memory device. The control circuit being configured to detect a spoken phrase from the user via the user interface device, convert the spoken phrase to a text string, generate a private key based at least on the text string, select a conversation record in the distributed conversation database based at least on the private key, decrypt the conversation record using the private key to retrieve information associated with a previous conversation, and resume, via the network connector and the user interface device, the previous conversation using the information stored in the conversation record.

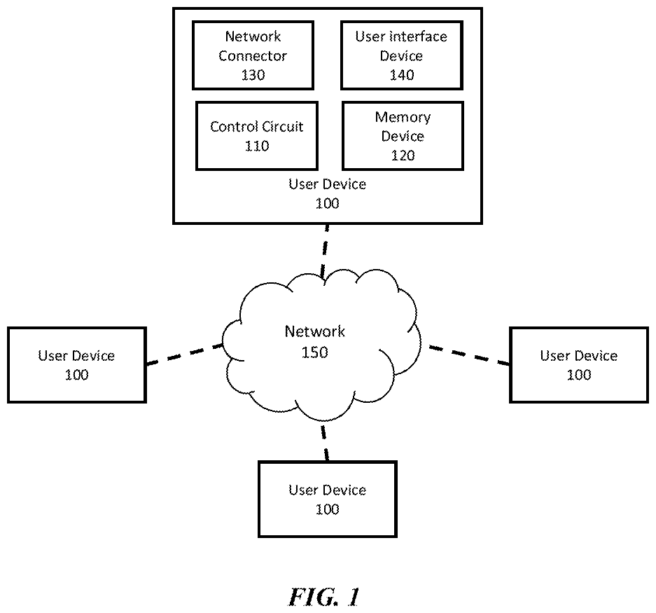

Referring now to FIG. 1, a system according to some embodiments is shown. The system includes a plurality of user devices 100 communicating over a network 150. A user device 100 may comprise a processor-based device comprising a control circuit 110, a memory device 120, a user interface device 140, and a network connector 130.

The user device 100 may generally refer to an electronic device configured to receive input from users and provide an output. In some embodiments, one or more of the user devices may be configured to use information stored in a distributed conversation database to provide interaction with a user. In some embodiments, user devices 100 in the system may comprise one or more of a personal assistance device, an internet of things (IoT) device, a smart appliance, a smartphone, a smart speaker, a vehicle, a robot, a computer, a tablet device, a display device, a virtual reality (VR) display device, an augmented reality (AR) display device, and the like. In some embodiments, the user devices 100 in the system may comprise nodes of a distributed conversation database that stores a plurality of conversation records. The distributed conversation database may be collectively updated and verified by a plurality of user devices 100 that function as nodes of the database. In some embodiments, the user devices 100 are configured to use the distributed conversation database to resume a conversation that was started on another device. In some embodiments, each conversation record may be encrypted by a public key associated with a private key that is generated based on the user's voice such that a user may use his/her voice to retrieve the conversation record and decrypt the content of the record at another device.

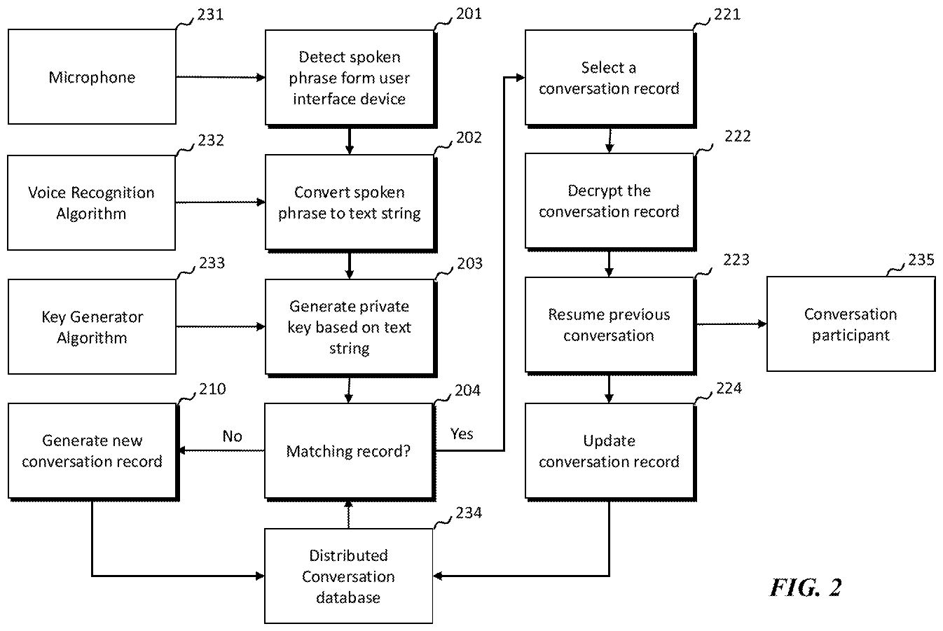

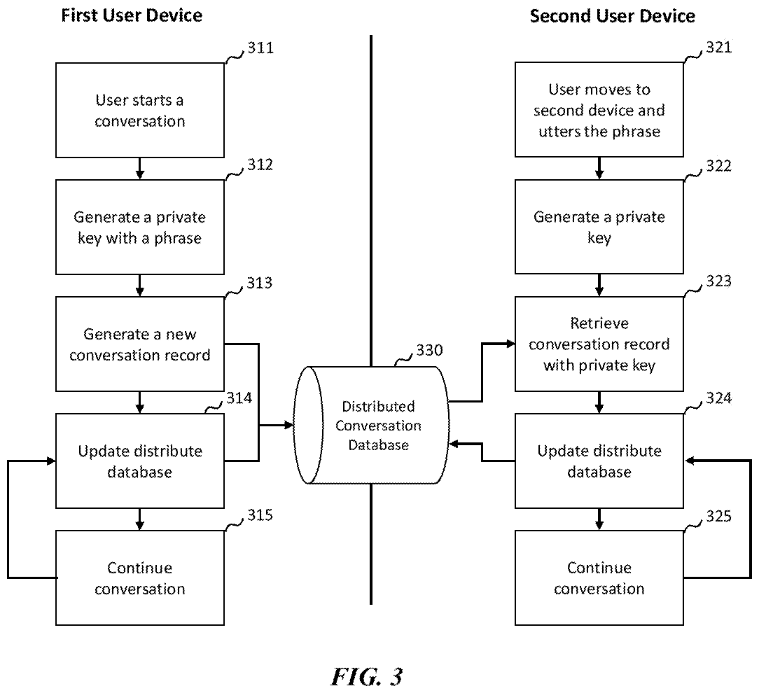

The control circuit 110 may comprise a central processing unit (CPU), a processor, a microprocessor, a microcontroller, an application specific integrated circuit (ASIC) and the like and is configured to execute computer-readable instructions stored in a computer-readable storage memory device 120. The computer-readable storage memory device 120 may comprise volatile and/or non-volatile memory and have stored upon it a set of computer-readable instructions which, when executed by the control circuit 110, causes the control circuit 110 to authenticate a user based on his/her voice and a distributed conversation database, retrieve a conversation record, and provide a conversation interaction with the user based on the conversation record. In some embodiments, the distributed conversation database may comprise a distributed digital ledger, a shared database, a blockchain, and/or blockchain-based database. In some embodiments, the memory device 120 is configured to store at least a portion of the distributed conversation database. In some embodiments, the control circuit 110 is further configured to periodically update and/or verify updates to the distributed conversation database. In some embodiments, the control circuit 110 may be configured to perform one or more steps described with reference to FIGS. 2 and 3 herein.

The user interface device 140 generally comprises electronic user input/output devices. In some embodiments, the user interface device 140 may comprise one or more of a microphone, a speaker, a camera, an optical sensor, a display screen, a hologram display, a projection display, a touch screen, a VR display, an AR display, one or more buttons, a keypad, a motion sensor, an eye sensor, etc. The user interface device 140 may be configured to provide input to the control circuit 110 for identifying and authenticating a user. In some embodiments, the user interface device 140 may further comprise input/output devices used for a carrying on a conversation with an artificial intelligence (AI) and/or another user.

The network connector 130 generally comprises a device configured to allow the user device 100 to communicate with other devices over the network 150. In some embodiments, the network connector 130 may comprise one or more of a local network adapter, an Ethernet port, a network port, a data port, a wireless network transceiver, a Wi-Fi transceiver, a cellular data transceiver, a Bluetooth transceiver, and the like. The network 150 may comprise one or more of a home network, a local area network, an IoT network, a Wi-Fi network, a private network, a virtual private network, an enterprise network, and/or the Internet.

The system shown in FIG. 1 may generally comprise any number of user devices of various types. The user devices 100 may be associated with different users and/or be utilized by different users at different times. The user devices 100 may collectively maintain a blockchain-based distributed conversation database as nodes of a blockchain. In some embodiments, one or more user devices 100 may be disconnected from the network 150 from time to time and the remaining devices may continue to maintain the distributed conversation database based on interactions with users. In some embodiments, additional user devices may access the distributed conversation database and provide similar functionalities through another user device that serves as a node of the distributed blockchain. For example, a home hub device may be configured to update and index the distributed conversation database and make the indexed information available to a plurality of devices in the same home network.

Referring now to FIG. 2, a method for providing a voice-initiated conversation interface on multiple devices is shown. In some embodiments, the steps shown in FIG. 2 may be performed by a networked processor-based device, such as one or more of the user devices 100 shown in FIG. 1, or other similar devices. In some embodiments, the steps may be performed by one or more of a personal assistance device, an internet of things (IoT) device, a smart appliance, a smartphone, a smart speaker, a vehicle, a robot, a computer, a tablet device, a display device, a virtual reality (VR) display device, an augmented reality (AR) display device, and the like. In FIG. 2, the device for performing the steps comprises a microphone 231, a processor implementing a voice recognition algorithm 232 and a key generator algorithm 233, and a memory storing at least portion of a distributed conversation database 234 that stores conversations records. In some embodiments, the voice recognition algorithm 232 and/or the key generator algorithm 233 may comprise a software and/or a hardware module. In some embodiments, the voice recognition algorithm 232 and the key generator algorithm 233 may be implemented locally at a user device or be provided through a remote server, an IoT hub, or another user device of the system. For example, in a group of user devices on a home network, a device with more processing power may execute the voice recognition algorithm 232 and/or the key generator algorithm 233 for one or more other devices.

In step 201, the system detects a spoken phrase from a user via a user interface device such as the microphone 231. In some embodiments, the spoken phrase may comprise a phrase identifying with a particular user (e.g. “hi, this is Ethan”), a particular conversation (e.g. “let's talk about soccer”), and/or a particular conversation participant 235 (e.g. “Wilma, I am here”). In some embodiments, a conversation partner may comprise an artificial intelligence voice assistance, a chatbot, or a human. In some embodiments, the system may impose a volume threshold in step 201 before triggering the user device to proceed to step 202. In some embodiments, the user may first “wake up” the user device prior to uttering the spoken phrase in step 201 by speaking another word or phrase or otherwise turning on the device. In some embodiments, the spoken phrase may activate the user device that was idle or on standby.

In step 202, the system uses a voice recognition algorithm 232 to convert the spoken phrase from step 201 into a text string. In some embodiments, voice recognition may be performed locally at the device or be performed by a remote server. The voice recognition algorithm 232 may comprise a known speech recognition algorithm. In some embodiments, voice recognition may further comprise a speaker recognition algorithm that identifies other acoustic features and patterns of the speaker's voice such as pitch, register, intonation, pacing, accent, etc.

In step 203, the system uses a key generator algorithm 233 to generate a private key based at least on the text string determined in step 202. In some embodiments, the system further determines voice frequency ranges associated with a plurality of segments of the spoken phrase, wherein the private key is generated further based on the voice frequency ranges. For example, the system may determine a frequency range for each syllable of the spoken phrase and use the frequency ranges as another input to the key generator algorithm. In some embodiments, the frequency ranges may be converted to relative numbers. For example, the frequency for the first syllable may be set to 1, and the remaining syllables are assigned a number based on how much their frequency range deviates from the first syllable such that the frequency of the spoken phrase is outputted as a set a whole numbers corresponding to the number of syllables in the spoken phrase. In some embodiments, the user device may further comprise a biometric sensor and the private key may be generated further based on one or more of a retinal scan, a facial image, and a fingerprint. In some embodiments, the user device may have stored on it, one or more user identifier associated with users who had previously registered with the device. In some embodiments, a user device may select a user identifier based on voice recognition or a biometric sensor and provide the user identifier to the key generator algorithm as an additional input. In some embodiments, the key generator algorithm may comprise any mathematical algorithm that is configured to take one or more of the text string, the voice feature information, user biometric data, and user identifier as input, and generate an alphanumeric string that may be used as a private key for a distributed database. Generally, when given the same input, the key generator algorithm 233 is configured to generate the same output key on each user device.

In step 204, the system determines whether any conversation record stored in the distributed conversation database 234 is a match to the spoken phrase. In some embodiments, the system indexes the distributed conversation database 234 of conversation records using the private key generated in step 203 to determine whether there is a record associated with the spoken phrase. For example, the system may determine whether a record contains a public key associated with the privet key. In some embodiments, the distributed conversation database 234 comprises one or more of a distributed hash chain database, a distributed ledger, or a blockchain database. In some embodiments, the distributed conversation data comprises a plurality of conversation records encrypted with public keys associated with each conversation and the conversation database is updated based on communications with the one or more other user devices via the network connector. In some embodiments, a conversation record comprises one or more of a conversation identifier, a service provider identifier, a service provider network address, one or more participant identifier, one or more participant network address, one or more device identifiers, and one or more conversation locations. In some embodiments, a service provider may comprise an AI assistance provider (e.g. Alexa, Siri). In some embodiments, a service provider may comprise a voice communication server provider (e.g. Skype, Google voice, etc.) In some embodiments, the conversation record may further comprise user information that may be utilized by an AI to tailor an interaction with the user. For example, the conversation record may comprise user demographic information, user preferences, user values, user affinities, past conversation history, user purchase history, etc. In some embodiments, the conversation records in the distributed conversation database 234 may comprise a public portion and a private encrypted portion. The public portion may comprise one or more of the conversation public key, the conversation time, the conversation location, etc. that user devices may use to match conversations with users. The private portion may comprise other information that, when decrypted, allows a conversation to be resumed with an AI entity and/or another human.

In some embodiments, the system may implement one or more rules for filtering the conversation records based on location and/or time. For example, the system may skip over any conversation record of conversations that took place more than an hour, two hours, a day, a week ago, etc. based on system determined and/or user configurable temporal consistency rules. In some embodiments, the system may check to spatial consistency and the conversation record is further selected based on a distance between the location of the user and the location of a previous conversation. For example, the system may compare the time and location of the end of one conversation and the time and location of the device that detected of the spoken phrase in step 201 to determine whether the movement of the user is within an expected distance for the time span. In some embodiments, the system determines that there is a matching record if a conversation record contains a public key matching the private key generated in step 203 and passes the filtering rules (e.g. temporal and spatial consistency rules) implemented by the system. In some embodiments, a user device may further verify that the conversation is not currently being provided via another user device such that only one device interacts with the user at the time. In some embodiments, a conversation record may be passed between devices similar to transactions of a cryptocurrency. For example, a second device may request a transfer from the first device by showing ownership of the private key. The first device may then transfer the conversation record to the second device through a blockchain transaction.

In step 210, the system generates a new conversation record in the distributed conversation database in the event that no conversation record in the distributed conversation database matches the private key. The new conversation record may comprise information associated with the user, information associated with one or more other participants of the conversation, the time of the conversation, the location of the conversation, the content of the conversation, the conversation topic, and the like. In some embodiments, at least a portion of the new conversation record is encrypted based on the private key generated in step 203. In some embodiments, step 210 may take place when the conversation is initiated or when the conversation concludes. The new conversation record may be sent out to other nodes of the distributed conversation database as an update to the database.

In step 221, the system selects a conversation record in the distributed conversation database. In some embodiments, the system selects the latest conversation record that matches the privet key. In some embodiments, the system may apply temporal and/or spatial consistency rules in selecting a conversation record. In some embodiments, step 221 and step 204 may be performed as one step.

In step 222, the system decrypts the conversation record using the private key to retrieve information associated with a previous conversation. The decrypted information may generally comprise information the user device may use to resume a previous conversation. In some embodiments, the decrypted information may be used to reestablish a communication channel with a conversation participant 235. For example, the decrypted information may comprise identifiers of the other conversation participant(s), session information, communication service identifying information, and/or authentication information that would allow the user to rejoin/resume the conversation. In some embodiments, for a conversation with another human, the conversation record may store communication channel information (e.g. VoIP phone, a messenger application, etc.) and a conversation participant identifier (e.g. username, phone number, etc.) In some embodiments, for a conversation with an AI entity, the decrypted information may identify a specific AI service and/or an AI chat session. In some embodiments, the conversation record may further store user or conversation information that may be used by an AI to customize the interaction based on the content of the previous conversation and/or the user's profile.

In step 223, the system resumes the previous conversation using the conversation record. In some embodiments, the previous conversation is resumed by reestablishing a communication channel between the user and one or more participant of the previous conversation via the user interface device and the network connector. In some embodiments, the user device may execute an application or load a web service based on the conversation record. For example, if a specific AI entity is identified in the conversation record, the user device may trigger the AI program, provide a user ID or a session ID to the AI program and allow the AI program to resume the conversation. For example, if the customer has been getting updates for a football game on a first user device, the user may move to a second device and simply ask “what's the score now?” and the AI may determine the relevant game based on the record of the previous conversation. In another example, if a customer service agent is identified in the conversation record, the user device may load the customer service website or application and use a session ID to reconnect the customer and the customer service agent.

In step 224, the user device updates the conversation record in the distributed conversation database 234. In some embodiments, the distributed conversation database 234 may be continuously updated as the conversation is carried on, with each new record referring to a previous record of the same conversation. For example, each time a user asks an AI a question during a conversation, an update record may be added that references the previous record. In some embodiments, the conversation record may be updated when the user device no long detects the presence of the user or when there is a long pause in the conversation. In some embodiments, updates to a conversation record may comprise a record added to the distributed database that comprises a hash of previous records. In some embodiments, when a record is added or updated, nodes of the distributed conversation database 234 may apply temporal and/or spatial consistency rules to verify and authenticate updates associated with new or existing conversation records.

In some embodiments, the steps shown in FIG. 2 may be carried out by a plurality of devices over the duration of a conversation. For example, if a user begins a conversation in a vehicle, moves to a kitchen, and then into the bedroom, the vehicle may perform step 210 when the conversation is initiated, and a smart refrigerator and a smart speaker may retrieve and update the records for the conversation as the presence of the user is detected at each location through the spoken phrase. In some embodiments, a user device may repeat the steps shown in FIG. 2 for different conversations and for different users at different times. In some embodiments, nodes of the distributed conversation database 234 may simultaneously use the distributed conversation database 234 to provide user interactions for a plurality of users and update the distributed conversation database 234 based on the steps shown in FIG. 2.

Referring now to FIG. 3, a method for providing a voice-initiated conversation interface on multiple devices is shown. In some embodiments, the steps shown in FIG. 3 may be performed by networked processor-based devices, such as one or more of the user devices 100 shown in FIG. 1, or other similar devices. In some embodiments, the steps may be performed by one or more of a personal assistance device, an internet of things (IoT) device, a smart appliance, a smartphone, a smart speaker, a vehicle, a computer, a tablet device, a display device, a virtual reality (VR) display device, an augmented reality (AR) display device, and the like. FIG. 3 shows an embodiment in which a conversation that is initiated on the first user device and resumed at the second user device using a distributed conversation database.

In step 311, a user starts a conversation at the first user device. In some embodiments, the user may start a conversation using a voice command and/or other user input devices such as a touchscreen. In step 312, the first user device generates a private key using a phrase for identifying the first conversation. For example, if the user begins the conversation with “connect me with Wilma,” this phrase may be used to generate the private key. In some embodiments, the conversation may be with another human or with a voice assistance service such as a virtual AI assistance. In some embodiments, the user device may prompt the user to say a phrase to associate with the conversation after the user indicates that he/she wishes to begin a conversation. The private key may be generated by a key generator algorithm based at least on the spoken phrase. In some embodiments, the private key may be generated based on characteristics of the user's voice. In some embodiments, the private key may be generated based on using speech recognition on the spoken phrase to determine a text string. In some embodiments, the key may further be generated based on other information such as user voice features, user identifier, user biometric information, etc. In step 313, the first user device generates a new conversation record to record information related to the conversation. In some embodiments, the conversation record comprises one or more of a conversation identifier, a service provider identifier, a service provider network address, one or more participant identifier, one or more participant network address, one or more device identifiers, and one or more conversation locations. In some embodiments, the conversation record further records the content of the conversation.

In step 314, the distributed conversation database 330 is updated with the new conversation record. In step 315, the first user device continues to facilitate the conversation with the user. In some embodiments, the first user device may update the conversation record in the distributed conversation database 330 as the conversation is carried on. The distributed conversation database comprises a plurality of conversation records that is collectedly updated and verified by a plurality of user devices functioning as nodes of the distributed database.

In step 321, the user moves to the second device and speaks a phrase that is detected by the second user interface device. In step 322, the second user interface device generates a private key based on the phrase. In some embodiments, step 322 may be similar to step 312. In step 323, the second user device retrieves a conversation record from the distributed conversation database 330 using the private key. In some embodiments, the system may retrieve the newest conversation record with a public key associated with the private key. In some embodiments, the second user device may further determine whether the conversation record complies with temporal and spatial consistency rules enforced by the system. In step 324, the second user device updates the distributed conversation database to indicate that the conversation is being resumed at the second user device. In some embodiments, the second user device may record the time and place of the resumed conversation. In some embodiments, step 324 may be similar to step 314. In step 325, the first user device continues to facilitate the conversation with the user. In some embodiments, the first user device may update the conversation record in the distributed conversation database 330 as the conversation is carried on.

While only two user devices are shown, the distributed conversation database 330 may be accessed and updated by any number of user devices. In some embodiments, the steps described in FIG. 3 may be repeated by different devices and the conversation may be similarly resumed at a third device, a fourth device, a fifth device etc. In some embodiments, a conversation resumed at the second user device may be passed back to the first user device. In some embodiments, the user may indicate the ending of a conversion by operating a user device (e.g. press “end” on a touchscreen) or by saying an ending phrase (e.g. “ok, goodbye”). The user device may update the distributed conversation database to indicate that the conversation has ended and should not be resumed at another device. In some embodiments, if a conversation is not picked back up within a set period of time (e.g. 10 minutes, 20 minutes, 1 day, etc.), the system enforced temporal consistency rules may functionally end the conversation by not allowing another user device to resume that conversation due to the lapse in time.

In some embodiments, one or more of the user devices described may comprise one or more localized IoT devices and controllers. For example, one or more of the user devices may form an IoT network. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI may be discarded depending upon the degree to which such KRI has any value based on local processing and evaluation of such KRI. In an exemplary embodiment, KM may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data.

In some embodiments, a smart device's AI may be an ether AI (EAI) implemented with a protocol shared between various IoT devices. The device that presents the shared IA may depend on where the user is and what the user is doing. A synchronized and evolving AI algorithm may leverage the unique capabilities of each device a user interacts with and the history of user interactions, and present a single voice from any given device that is in use at the moment. The ether AI and its associated voice may travel with a user using a system of devices even though some the individual devices may be stationary. For example, an AI voice might emanate from the TV during a football game, jump to the smartphone on a halftime trip to a store, jump to a robot cart to assist shopping, and then provide navigation on the way home. The ether AI (EAI) may be configured to be attuned to the users' immediate needs and may determine affinity information based on a user's actions and purchases. In some embodiments, the user may “bottle” the EAI up inside a home device such as the smartphone until an action triggers the EAI to come out. In some embodiments, an EAI may take a visual form as an avatar appealing to its user using AR, VR, projection, a standard screen, or other display techniques.

In some embodiments, to protect the integrity of the EAI from device to device, an EAI's data may be stored in a public ledger such as a blockchain. In some embodiments, an EAI may use devices to communicate with a user but is not tied to a specific device. In some embodiments, a user may visit a home of the EAI in VR. In some embodiments, the blockchain database of the EAI may be configured to not permit the EAI to interface with the user from more than one place or one device at a time—though it may be accessing information from many devices simultaneously—in order to maintain the sense of individuality. In some embodiments, a blockchain maintains EAI as a singular item such as token and a coin.

In some embodiments, an EAI blockchain comprises a peer-to-peer authentication system for storing the AI algorithm and/or data unique to the individual EAI (item) that allows online interactions to take place directly between two or more parties or devices without going through one or more trusted intermediaries. In some embodiments, the peer-to-peer network timestamps actions, hashing them into an ongoing chain of hash-based proof-of-work code to form a record that cannot be changed without redoing the proof-of-work. The longest chain distributed on the peer-to-peer network proves that the data have existed at the time in order to get into the hash, thereby proving the sequence of events witnessed, thereby proving the integrity of the AI algorithm and data EAI (digitized document) has been maintained. When a new block is added, a new chain becomes the longest block and the digitized content is moved to the receiving party. In some embodiments, the authentication system utilizes one or more aspects of conventional blockchain systems. In some embodiments, the system allows the use of digitized AI algorithm and data EAI (item) based on cryptographic proof instead of trust, allowing any two or more willing parties or devices to share the content without the need to trust each other and without the need for a trusted intermediary.

In some embodiments, the system separates the EAI and physical devices such that the loss of a device does not damage the EAI, and the single device could present multiple EAIs for different users. An EAI is generally not device dependent but can reside on any device that shares IoT communication protocols. In some embodiments, an EAI combines its blockchain-protected AI algorithm and data with the tools afforded by the given device to offer intelligent solutions to the user that becomes a part of the EAI's experience on behalf of the user. In some embodiments, an EAI may track the user to an appropriate device automatically. In some embodiments, an EAI may perform tasks specific to the inhabited device. For example, the EAI may provide instructions to operate the device based on a machine language or natural language menu of the device. The EAI may also affect how the device is operated based on understanding affinities and preferences of the user. In some embodiments, the EAI generate device-specific warnings, for example, the EAI may voice a warning when a smartphone senses too much pressure to prevent damages to the screen. In some embodiments, an avatar of an EAI may be projected, displayed on a screen, in VR, in AR, in a hologram, or take other visual forms. In some embodiments, the EAI may interact with the user and/or the environment using sensors on a particular device. For examples, on a device with a touch sensor, the EAI may be triggered by touching a particular area to cause an AR hologram to be displayed. In some embodiments, information collected by the EAI may be used for product recommendation. In some embodiments, the integrity of the EAI may be maintained through a blockchain so it cannot be tampered with, split, or inhabit more than one device simultaneously. In some embodiments, what is considered a device could vary in size, for example, a single microwave or a house that contains the microwave may be a device that presents the EAI. In some embodiments, an EAI may use customer or associate genome data to interact with users.

In some embodiments, the system may allow a user to verbally communicate with various types of IoT devices using a virtual assistant. This virtual assistant is configured to move from device to device as the user moves throughout his home, in his car, on his smartphone, etc. Additionally, the context of the user's recent conversations with the system may also travel so that the system may know the context of a user request that was initiated several minutes ago, from a different device.

In some embodiments, conversations may be stored in a blockchain shared by the devices. The user may be authenticated using the public/private key aspect of a blockchain. Voiceprint technology may be used to authenticate the user. Also, a start phrase and an ending phrase may be used to initiate and end actions by the system. In some embodiments, as the user moves around the house, the system may verify the user's change in location and allow the user to remain authenticated if the change in position or time is within a threshold. In some embodiments, the system may prevent the user from simultaneously access the EAI and/or the same conversation from multiple places at once.

In some embodiments, the virtual assistant may connect to the user's customer value vectors and make use of values and preferences of the user in interacting with the user. This may allow the user to issue simplified commands, for example, order dinner by simply saying “get me an order of Thai Basil.” In some embodiments, the system may add records to the blockchain when the customer gets authenticated, makes a request, moves to another location, and/and procures a product or service.

In some embodiments, the system may be device agnostic, such that any IoT device with a speaker and microphone may be added to the network. These devices may communicate with each other wirelessly using Bluetooth, WiFi or other RF communication techniques. In some embodiments, the virtual assistant can appear on display devices which can “talk” to the user and show items to the user for review.

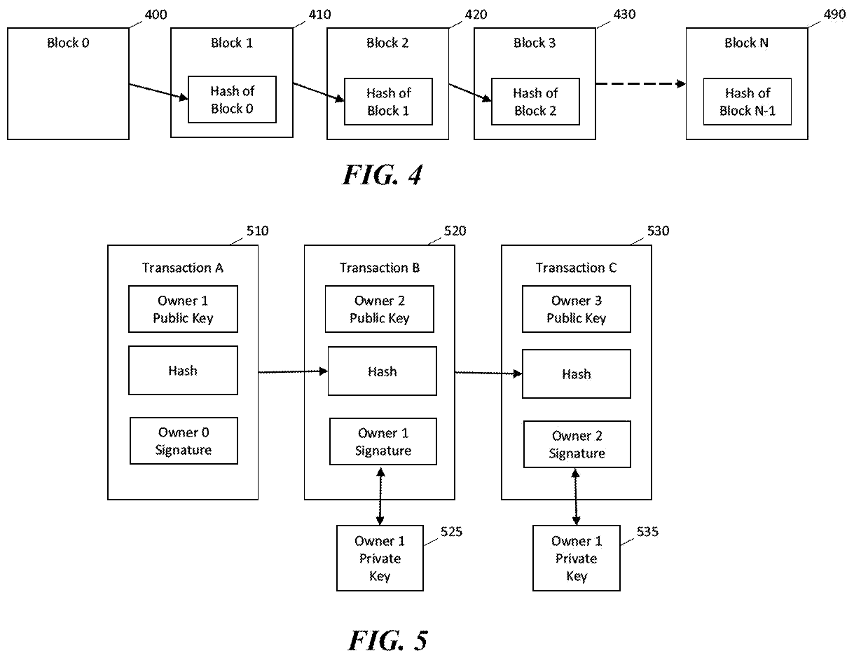

Descriptions of some embodiments of blockchain technology are provided with reference to FIG. 4-9 herein. In some embodiments of the invention described above, blockchain technology may be utilized to record conversation information for the user devices described with reference to FIGS. 1-3 herein. One or more of the user devices described herein may comprise a node in a distributed blockchain system storing a copy of the blockchain record. Updates to the blockchain may comprise new conversation records and updates to existing conversation records, and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners” are nodes that compete to provide proof-of-work to form a new block, and the first successful miner of a new block earns Bitcoin currency in return.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 520. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

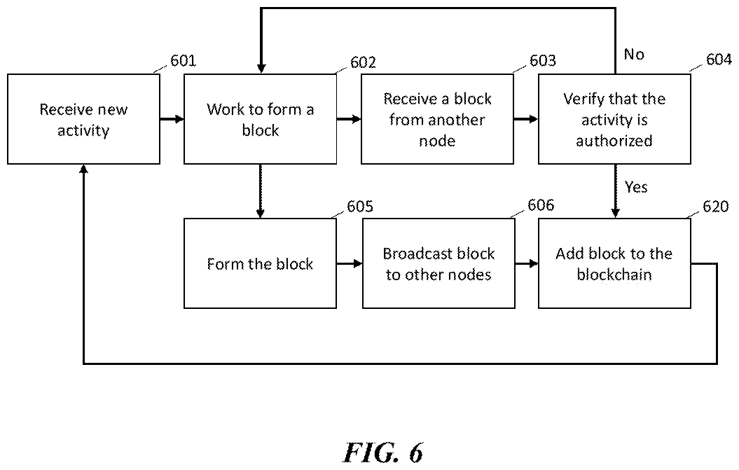

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

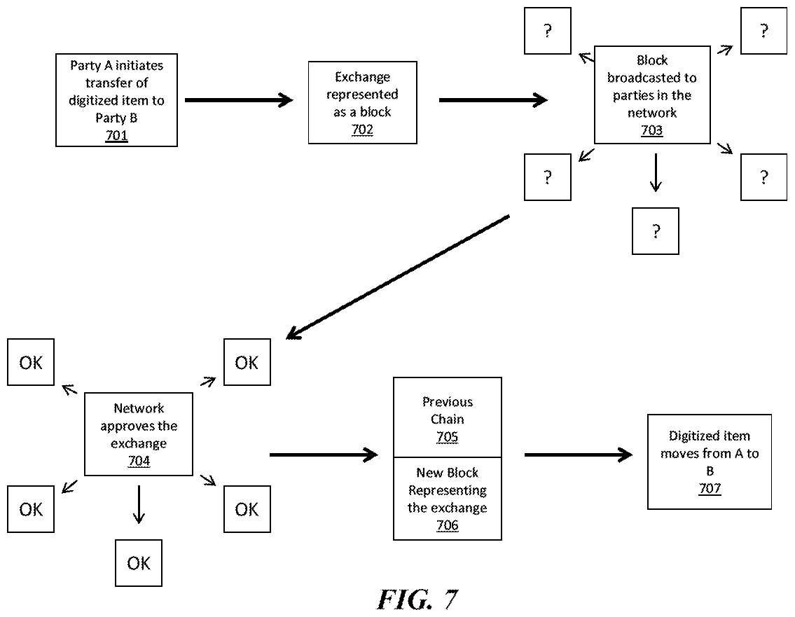

Now referring to FIG. 7, a process diagram a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

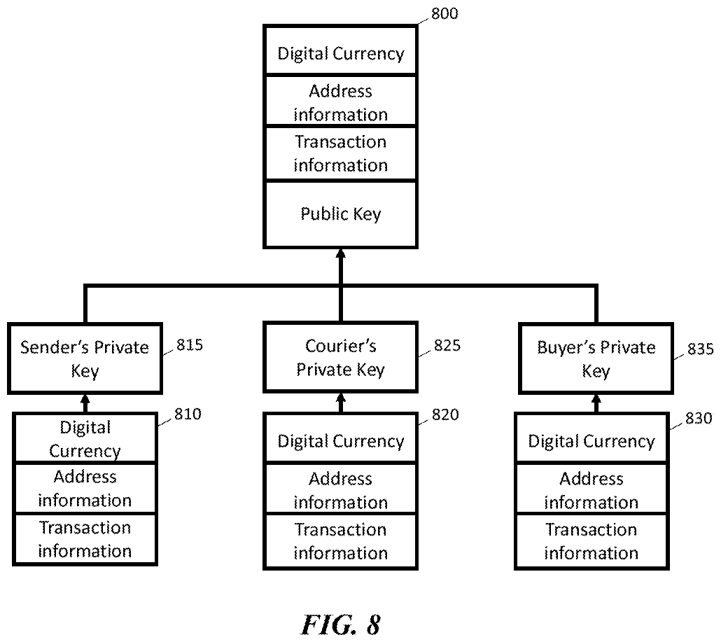

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

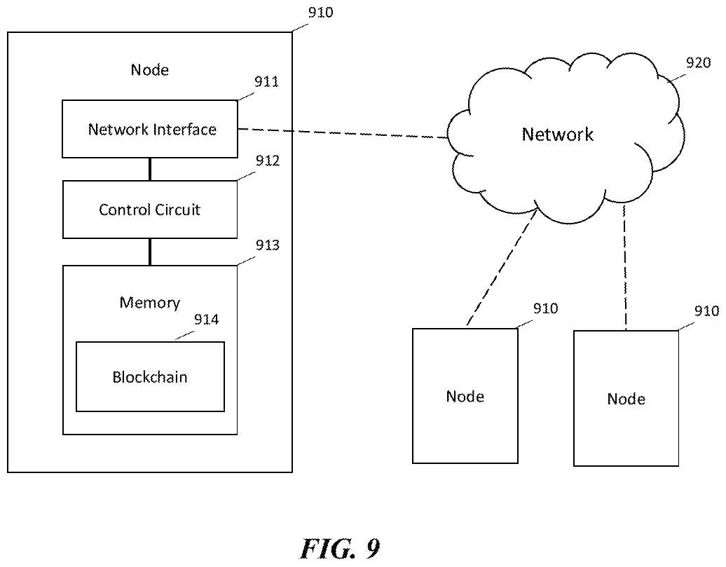

Now referring to FIG. 9, a system according to some embodiments is shown. A distributed blockchain system comprises a plurality of nodes 910 communicating over a network 920. In some embodiments, the nodes 910 may be comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer-readable instructions stored on a computer-readable storage memory 913. The computer-readable storage memory may comprise volatile and/or non-volatile memory and have stored upon it a set of computer-readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In some embodiments, a system for providing a voice-initiated conversation interface on multiple devices comprises a network connector configured to communicate with one or more other user devices over a network, a user interface device configured to communicate with a user, a memory device storing at least a portion of a distributed conversation database, wherein the distributed conversation database comprises a plurality of conversation records encrypted with public keys associated with each conversation and conversation database is updated based on communications with the one or more other user devices via the network connector, and a control circuit coupled to the network connector, the user interface device, and the memory device. The control circuit is configured to detect a spoken phrase from the user via the user interface device, convert the spoken phrase to a text string, generate a private key based at least on the text string, select a conversation record in the distributed conversation database based at least on the private key, decrypt the conversation record using the private key to retrieve information associated with a previous conversation, and resume, via the network connector and the user interface device, the previous conversation using the information stored in the conversation record.

In some embodiments, a method for providing a voice-initiated conversation interface on multiple devices comprises detecting, with a control circuit of a user device, a spoken phrase from a user via a user interface device configured to communicate with the user, converting, with the control circuit, the spoken phrase to a text string, generating, with the control circuit, a private key based at least on the text string, selecting a conversation record in a distributed conversation database based at least on the private key, wherein the distributed conversation database comprises a plurality of conversation records encrypted with public keys associated with each conversation and the distributed conversation database is updated based on communications with one or more other user devices via a network connector coupled to the control circuit, decrypting, with the control circuit, the conversation record using the private key to retrieve information associated with a previous conversation, and resuming, via the network connector and the user interface device, the previous conversation using the information stored in the conversation record.

In some embodiments, an apparatus for providing a voice-initiated conversation interface on multiple devices comprises a non-transitory storage medium storing a set of computer-readable instructions and a control circuit configured to execute the set of computer-readable instructions which causes to the control circuit to: detect a spoken phrase from a user via a user interface device configured to communicate with the user, convert the spoken phrase to a text string, generate a private key based at least on the text string, select a conversation record in a distributed conversation database based at least on the private key, wherein the distributed conversation database comprises a plurality of conversation records encrypted with public keys associated with each conversation and the distributed conversation database is updated based on communications with one or more other user devices via a network connector coupled to the control circuit, decrypt the conversation record using the private key to retrieve information associated with a previous conversation, and resume, via the network connector and the user interface device, the previous conversation using the information stored in the conversation record.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for providing a voice-initiated conversation interface on multiple devices, comprising:
a network connector configured to communicate with one or more other user devices over a network;
a user interface device configured to communicate with a user;
a memory device storing at least a portion of a distributed conversation database, wherein the distributed conversation database comprises a plurality of conversation records encrypted with public keys associated with each conversation and conversation database is updated based on communications with the one or more other user devices via the network connector;
a control circuit coupled to the network connector, the user interface device, and the memory device, the control circuit being configured to:
detect a spoken phrase from the user via the user interface device;
convert the spoken phrase to a text string;
generate a private key based at least on the text string;
select a conversation record in the distributed conversation database based at least on the private key;
decrypt the conversation record using the private key to retrieve information associated with a previous conversation; and
resume, via the network connector and the user interface device, the previous conversation using the information stored in the conversation record.

2. The system of claim 1, wherein the control circuit is further configured to: determine voice frequency ranges associated with a plurality of segments of the spoken phrase, wherein the private key is generated further based on the voice frequency ranges.

3. The system of claim 1, wherein the private key is generated further based on one or more of a retinal scan, a facial image, and a fingerprint.

4. The system of claim 1, wherein the conversation record is further selected based on a distance between the user and a previous conversation location.

5. The system of claim 1, wherein the conversation record comprises one or more of a conversation identifier, a service provider identifier, a service provider network address, one or more participant identifier, one or more participant network address, one or more device identifiers, and one or more conversation locations.

6. The system of claim 1, wherein the previous conversation is resumed by reestablishing a communication channel between the user and one or more participant of the previous conversation via the user interface device and the network connector.

7. The system of claim 1, wherein the distributed conversation database comprises one or more of a distributed hash chain database, a distributed ledger, and a blockchain database.

8. The system of claim 1, wherein the control circuit is further configured to update the conversation record using the private key.

9. The system of claim 1, wherein the control circuit is further configured to generate a new conversation record in the distributed conversation database in the event that no conversation record in the distributed conversation database matches the private key.

10. The system of claim 1, wherein the user interface device comprises one or more of a microphone, a speaker, a camera, an optical sensor, a display screen, a hologram display, and a projection display.

11. A method for providing a voice-initiated conversation interface on multiple devices, comprising:
detecting, with a control circuit of a user device, a spoken phrase from a user via a user interface device configured to communicate with the user;
converting, with the control circuit, the spoken phrase to a text string;
generating, with the control circuit, a private key based at least on the text string;
selecting a conversation record in a distributed conversation database based at least on the private key, wherein the distributed conversation database comprises a plurality of conversation records encrypted with public keys associated with each conversation and the distributed conversation database is updated based on communications with one or more other user devices via a network connector coupled to the control circuit;
decrypting, with the control circuit, the conversation record using the private key to retrieve information associated with a previous conversation; and
resuming, via the network connector and the user interface device, the previous conversation using the information stored in the conversation record.

12. The method of claim 11, further comprising: determining voice frequency ranges associated with a plurality of segments of the spoken phrase, wherein the private key is generated further based on the voice frequency ranges.

13. The method of claim 11, wherein the private key is generated further based on one or more of a retinal scan, a facial image, and a fingerprint.

14. The method of claim 11, wherein the conversation record is further selected based on a distance between the user and a previous conversation location.

15. The method of claim 11, wherein the conversation record comprises one or more of a conversation identifier, a service provider identifier, a service provider network address, one or more participant identifier, one or more participant network address, one or more device identifiers, and one or more conversation locations.

16. The method of claim 11, wherein resuming the previous conversation comprises reestablishing a communication channel between the user and one or more participant of the previous conversation via the user interface device and the network connector.

17. The method of claim 11, wherein the distributed conversation database comprises one or more of a distributed hash chain database, a distributed ledger, and a blockchain database.

18. The method of claim 11, further comprising:
updating the conversation record using the private key.

19. The method of claim 11, further comprising:
generating a new conversation record in the distributed conversation database in the event that no conversation record in the distributed conversation database matches the private key.

20. An apparatus for providing a voice-initiated conversation interface on multiple devices comprising:
a non-transitory storage medium storing a set of computer-readable instructions; and
a control circuit configured to execute the set of computer-readable instructions which causes to the control circuit to:
detect a spoken phrase from a user via a user interface device configured to communicate with the user;
convert the spoken phrase to a text string;
generate a private key based at least on the text string;
select a conversation record in a distributed conversation database based at least on the private key, wherein the distributed conversation database comprises a plurality of conversation records encrypted with public keys associated with each conversation and the distributed conversation database is updated based on communications with one or more other user devices via a network connector coupled to the control circuit;
decrypt the conversation record using the private key to retrieve information associated with a previous conversation; and
resume, via the network connector and the user interface device, the previous conversation using the information stored in the conversation record.
